(19) United States
(12) Patent Application Publication
(10) Pub. No.: US 2011/0020580 A1
(43) Pub. Date: Jan. 27, 2011

(54) FLEXIBLE CORNER TRIM PRODUCT

(76) Inventor: Gregory A. Amundson, Scandia, MN (US)

Correspondence Address: PATTERSON THUENTE CHRISTENSEN PEDERSEN, P.A., 4800 IDS CENTER, 80 SOUTH 8TH STREET, MINNEAPOLIS, MN, 55402-2100, US

(21) Appl. No.: 12/843,582

(22) Filed: Jul. 26, 2010

Related U.S. Application Data
(60) Provisional application No. 61/228,757, filed on Jul. 27, 2009.

(51) Int. Cl. E04F 19/02; B32B 3/02; B29C 65/48; E04B 1/68

(52) U.S. Cl. 428/58; 428/81; 156/249

(57) ABSTRACT

A trim piece for sealing a work surface including a body having a first side, a second side, and a span disposed between the first side and the second side, wherein the first side and the second side are joined at a junction defining an angle between the first side and the second side of between 80 degrees and 100 degrees, a topcap is affixed to the span of the body, wherein the topcap includes a left side having a first wing and a right side having a second wing, an adhesive is bonded to the first side of the body and an aperture is disposed within the body.

### RELATED APPLICATION

The present application claims the benefit of U.S. Provisional Application No. 61/228,757 filed Jul. 27, 2009, entitled “Flexible Caulking Product”, which is incorporated herein in its entirety by reference.

### FIELD OF THE INVENTION

The present invention generally relates to building products, and more particularly to flexible corner trim material for new construction, remodeling, kitchen and bathroom applications.

### BACKGROUND OF THE INVENTION

Flexible “caulking” products have been used exclusively for many years to seal corners of plumbing fixtures and finished wall and floor products. These corners commonly range from 25 to 90 degrees. In addition, certain caulk products are required in commercial applications for food prep and public eating establishments. Caulking products typically include numerous silicone based products, latex based products, polyurethane and many other materials. Unfortunately, with caulk being very flexible and almost fluid like in texture the finished application depends entirely on the skill of the applicator, surface condition and accessibility. A proper seal is often times not achieved and the end result can look very poor in appearance, dirty and poorly adhered to the substrate. In addition, improperly applied caulking products on horizontal surfaces can leave recessed areas that collect dirt and bacteria creating health hazards and aesthetically unappealing finishes.

The use of a fluid caulk product is also problematic because caulk products tend to expire over time as they cure in the container. Moreover, traditional caulk containers require the availability of a caulk gun to apply the caulking material to a surface in a desirable manner. In some instances, it is not possible to complete a caulking project when the caulk gun is missing among a construction site.

Research into other available products to solve the mess and inaccuracies of caulk have not revealed suitable options. There have been numerous applicators that try to aid in the application of caulk to achieve more desirable results but they still rely on the “base” product being a caulk material.

### SUMMARY OF THE INVENTION

The present invention provides a simple finished corner trim product without requiring the skill level for application that caulk does or the accessibility of a caulk gun. The present invention also provides a product that will not expire over time and/or become unusable do to curing in partial tubes.

The present invention includes a corner trim material composed of a single or multiple density extruded PVC, TPO, bio based polymer, EcoFlex, Elvax (or similar) product. The extrusion is defined by a cross section of between ⅛″ and 4″. In a preferred embodiment, the extrusion includes a 25-160 degree wedge.

In an alternative embodiment, the extrusion includes a single “leg” with a variable wedge shape at the bottom with a flat finished “cap” that has a variable proportioned “wing” on each side. The “wings” are an integral part of the trim as it is more flexible than the top cap and will contour itself to the irregularities of the surface being adhered to. The wedge and leg has 3M VHB Tape (or similar adhesive product), manufactured by 3M Company of St. Paul, Minn., applied to one or both sides of the wedge or leg to adhere the product to any surface and also to provide a tight bond and seal.

In another embodiment, the invention includes a trim piece for sealing a work surface. The trim piece has a body that includes a first side, a second side, and a span disposed between the first side and the second side. The first side and the second side are joined at a junction. A topcap is affixed to the span of the body. The topcap includes a left side and a right side and adhesive is bonded to the first side of the body.

In yet another embodiment, the invention includes a trim piece for sealing a work surface including a body having a first side, a second side, and a span disposed between the first side and the second side. The first side and the second side are joined at a junction defining an angle between the first side and the second side of between 80 degrees and 100 degrees. A topcap is affixed to the span of the body. The topcap includes a left side having a first wing and a right side having a second wing. An adhesive is bonded to the first side of the body and an aperture is disposed within the body.

In still another embodiment, the invention includes method for sealing a void in a work surface. The method includes the step of obtaining trim piece having a body including a first side, a second side, and a span disposed between the first side and the second side. The first side and the second side are joined at a junction defining an angle between the first side and the second side of between 80 degrees and 100 degrees. The topcap is affixed to the span of the body, wherein the topcap includes a left side having a first wing and a right side having a second wing. Adhesive is bonded to the first side of the body, wherein the adhesive includes a removable cover. An aperture is disposed within the body. The method further includes the step of removing the removable cover from the adhesive and placing the adhesive in contact with the work surface such that the junction of the trim piece is disposed within the void.

### BRIEF DESCRIPTION OF THE DRAWINGS

FIG. 1 is a cross-sectional view of the trim piece in accordance with the present invention.

FIG. 2 is a cross-sectional view of an alternative embodiment of the trim piece in accordance with the present invention.

FIG. 3 is a cross-sectional view of an alternative embodiment of the trim piece in accordance with the present invention.

FIG. 4 is a cross-sectional side view of an alternative embodiment of the trim piece in accordance with the present invention.

FIG. 5 is a cross-sectional side view of a leg in accordance with the present invention.

### DETAILED DESCRIPTION OF THE INVENTION

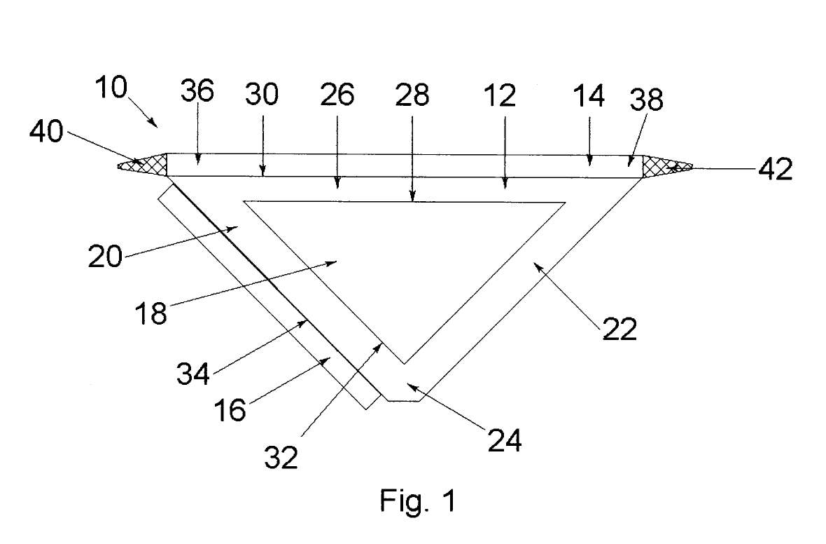

With reference to FIG. 1, a cross-sectional view of trim piece 10 is shown. It should be understood that trim piece 10 is not-specific in length. Rather, it is preferably fabricated during an extrusion process and can be trimmed to a length that is suitable for a specific application. As a fundamental matter, it should be understood that the trim piece is flexible. As such, it can be manipulated to conform to a desired surface.

Trim piece 10 is defined by body 12, topcap 14 and adhesive 16. In a preferred embodiment, body 12 has a triangular cross-sectional shape that includes aperture 18. Aperture 18 serves as a cooling tunnel that is useful in forming trip piece 10.

Body 12 includes first side 20 and second side 22. In a preferred embodiment, first side 20 and second side 22 are substantially equal in length. First side 20 and second side 22 intersect at junction 24. In a preferred embodiment, junction 24 has a substantially flat configuration to provide clearance when trim piece 10 is applied to a surface. Opposite body 12 from junction 24 is span 26. Span 26 extends from first side 20 to second side 22. In a preferred embodiment, the angle between first side 20 and second side 22 at junction 24 is between 80 degrees and 100 degrees, preferably 90 degrees.

Span 26 includes an interior side 28 and an exterior side 30. Topcap 14 is disposed about the exterior side 30 of span 26, and provides an aesthetically pleasing surface that serves as the visible portion of trim piece 10.

First side 20 includes an interior side 32 and an exterior side 34. Adhesive 16 is bonded to exterior side 34 and serves to fasten trim piece 10 to a work surface. It should be appreciated that adhesive 16 may be bonded to exterior side 34 by a wide array of mechanical or chemical means while remaining within the scope of the invention.

Topcap 14 includes a left side 36 and a right side 38. Wings 40 and 42 are disposed on left side 36 and right side 38 respectively. Wings 40 and 42 include a tapered configuration that provides a smooth surface that contacts the work surface to provide a smooth, even appearance as trim piece 10 abuts a work surface.

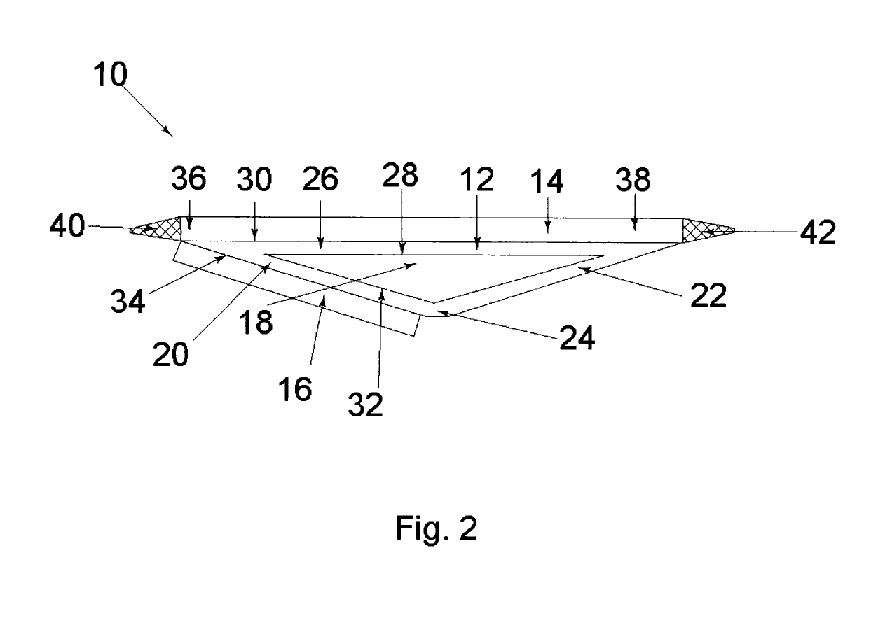

FIG. 2 shows a cross-sectional configuration of an alternative embodiment of trim piece 10. In this embodiment, the angle between first side 20 and second side 22 at junction 24 is between 150 degrees and 170 degrees, preferably 160 degrees.

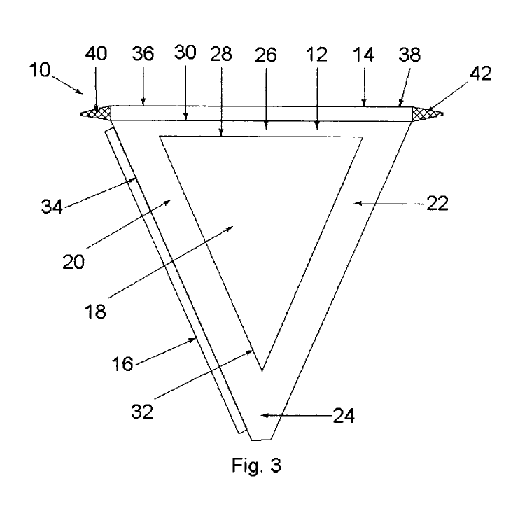

FIG. 3 shows a cross-sectional configuration of an alternative embodiment of trim piece 10. In this embodiment, the angle between first side 20 and second side 22 at junction 24 is between 15 degrees and 35 degrees, preferably 25 degrees.

The angled trim end or wings 40 and 42 will be proportionally variable in length and will terminate in a point that is approximately 10 degrees off of the line of the horizontal topcap 14. This angled point or wing 40 and 42 ensures the trim piece 10 will follow the irregularities of the surface being adhered to, thus creating as tight a seal as possible.

Each of the first side 20 and second side 22 of the trim piece 10 may include adhesive 16 depending on the application. In some embodiments, adhesive 16 may be disposed on both first side 20 and second side 22. In a preferred embodiment, adhesive 16 is only disposed on first side 20, as shown in FIG. 1. In a preferred embodiment, adhesive 16 is a 3M VHB (Very High Bond) tape manufactured by 3M Company of St. Paul, Minn. or similar product. The width and depth of the tape will depend on the extruded size of the respective first side 20 and second side 22. In a preferred embodiment, adhesive 16 will range from between ⅛″ in width up to 3″ in width. The thickness of the adhesive 16 will range from 0.025 mm up to ⅛″.

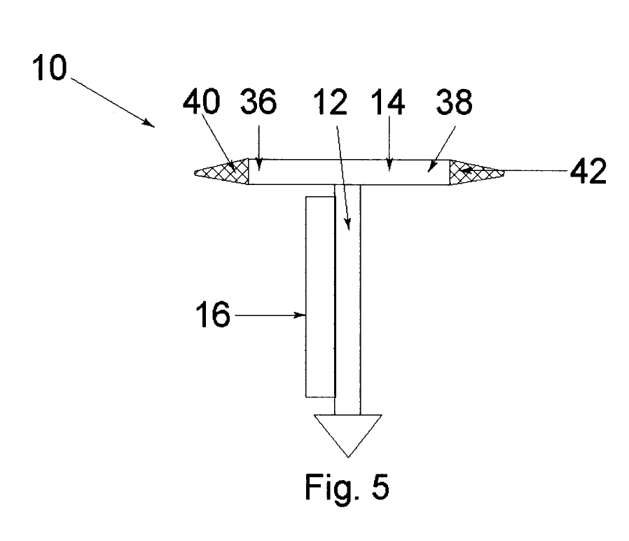

With reference to FIG. 5, the body 12 will have adhesive 16 on one of both sides tape depending on the application. The tape will be a 3M VHB (Very High Bond) tape manufactured by 3M Company of St. Paul, Minn. or similar product. The width and depth of the tape will depend on the extruded size of the Invention and will range from ⅛″ in width up to 3″ in width. The thickness of the tape will range from 0.025 mm up to ⅛″. The adhesive 16 may be mechanically or chemically bonded to the first side 20, second side 22, or the body 12 of the trim piece 10 following the extrusion process. In a preferred embodiment, adhesive 16 includes a removable protective cover for the end user to remove during the installation process. The protective cover can comprise a peel-off strip. In another preferred embodiment, the protective cover of adhesive 16 includes an extended section of cover that will extend beyond the extruded end of the trim piece 10 to facilitate on site removal of the cover prior to application. This cover extension is between ⅛″ and 1.5″ in length and will have the adhesive 16 removed.

With reference to FIGS. 1-3, the body 12 of trim piece 10 will now be discussed. Junction 24 of the trim piece 10 preferably has a small flat “void” area which will allow for imperfections in the corner material that the trim piece 10 is applied to. This flat void will be variable in width depending on the extruded size of the invention. In a preferred embodiment, the actual size will range from 1/32″ on up to ½″.

The body 12 of trim piece 10 shall be an extrusion of PVC, TPO, Bio based polymer, EcoFlex, Elvax (or similar) product of the same density than the topcap 14. Both the topcap 14 and the body 12 may be a single or multiple durometer extrusion which will fuse both pieces together. The aperture 18 is hollow to aid in the cooling of the body 12 during the extrusion process. The aperture 18 will also aid the trim piece 10 in being applied to tight radius inner and outer corners and still maintain the ability of the wings 40 and 42 to make proper contact with the subsurface.

The configuration of topcap 14 will now be discussed. The top cap is comprised of PVC, TPO, Bio based polymer, EcoFlex, Elvax (or similar) material in variable widths depending on the final extrusion dimension and will range, in a preferred embodiment, from ¼″ on up to 4″. The depth of the topcap 14 will also depend on the final extrusion dimension and application. The length of the topcap 14 is dependent upon the overall length of the final trim piece 10. This piece will be a part of the single or multiple durometer extrusion and may be extruded with a denser PVC, TPO, Bio based polymer, EcoFlex, Elvax (or similar) material. The topcap 14 can be extruded in any color and also can be finished with a film of any color or pattern which would be applied during the extrusion process along with custom printed logos and designs for a particular vendor. In addition, the topcap 14 may also be produced with a porous finished film that can be later stained to match the adjacent material it is being applied to.

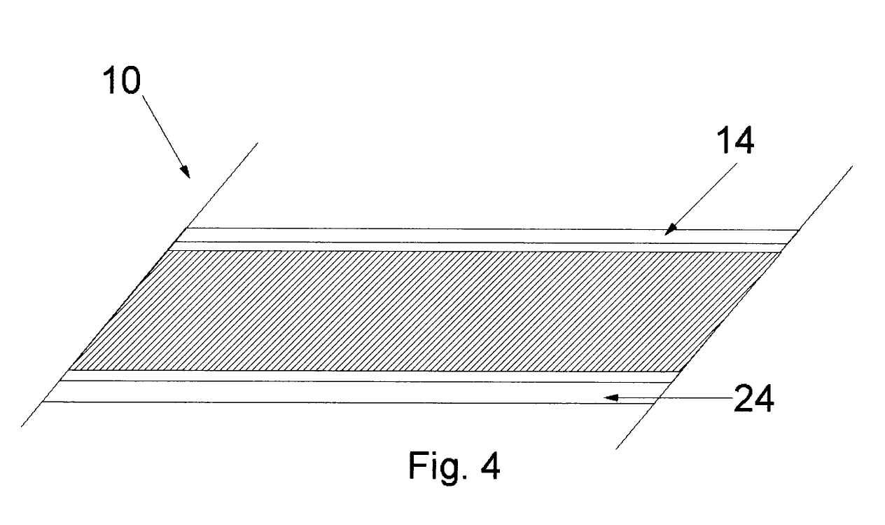

With reference to FIG. 4, additional details of trim piece 10 will now be discussed. FIG. 4 shows a side elevation view showing the angled edge of the topcap. This view shows the 3M VHB (Very High Bond) tape manufactured by 3M Company of St. Paul, Minn. or similar product running the entire length of the trim piece 10. The length and width will vary depending on the final size of the extrusion and the overall length of the extrusion. The bottom tip of the junction 24 is also shown.

The invention having been disclosed in connection with the foregoing variations and examples, additional variations will now be apparent to persons skilled in the art. The invention is not intended to be limited to the variations specifically mentioned, and reference should be made to the drawings rather than the foregoing discussion of preferred examples, to assess the scope of the invention.

1. A trim piece for sealing a work surface, the trim piece comprising:
a body including a first side, a second side, and a span disposed between the first side and the second side, wherein the first side and the second side are joined at a junction;
a topcap affixed to the span of the body, wherein the topcap includes a left side and a right side;
adhesive bonded to the first side of the body.

2. The trim piece of claim 1 further comprising a first wing disposed on the left side of the topcap and a second wing disposed on the right side of the topcap.

3. The trim piece of claim 2, further comprising an aperture disposed within the body.

4. The trim piece of claim 3, wherein the junction forms an angle between the first side and the second side between 80 degrees and 100 degrees.

5. The trim piece of claim 3, wherein the junction forms an angle between the first side and the second side between 150 degrees and 170 degrees.

6. The trim piece of claim 3, wherein the junction forms an angle between the first side and the second side between 15 degrees and 35 degrees.

7. The trim piece of claim 3, wherein the body is fabricated from an extrusion process.

8. The trim piece of claim 7, wherein the body is fabricated from a dense PVC material.

9. The trim piece of claim 7, wherein the body is fabricated from a TPO material.

10. The trim piece of claim 7, wherein the body is fabricated from a bio based polymer.

11. The trim piece of claim 7, wherein the body is fabricated from an EcoFlex material.

12. The trim piece of claim 7, wherein the body is fabricated from an Elvax material.

13. A trim piece for sealing a work surface, the trim piece comprising:
a body including a first side, a second side, and a span disposed between the first side and the second side, wherein the first side and the second side are joined at a junction defining an angle between the first side and the second side of between 80 degrees and 100 degrees;
a topcap affixed to the span of the body, wherein the topcap includes a left side having a first wing and a right side having a second wing;
adhesive bonded to the first side of the body;
an aperture disposed within the body.

14. The trim piece of claim 13, wherein the first wing and the second wing are tapered at an angle of 10 degrees from the horizontal line of the topcap.

15. The trim piece of claim 14, further comprising adhesive bonded to the second side of the body.

16. The trim piece of claim 15, wherein the junction is substantially flat.

17. The trim piece of claim 15, wherein the adhesive is comprised of VHB tape.

18. A method for sealing a void in a work surface, the method comprising:
obtaining trim piece having:
a body including a first side, a second side, and a span disposed between the first side and the second side, wherein the first side and the second side are joined at a junction defining an angle between the first side and the second side of between 80 degrees and 100 degrees;
a topcap affixed to the span of the body, wherein the topcap includes a left side having a first wing and a right side having a second wing;
adhesive bonded to the first side of the body, wherein the adhesive includes a removable cover;
an aperture disposed within the body;
removing the removable cover from the adhesive; and
placing the adhesive in contact with the work surface such that the junction of the trim piece is disposed within the void.

19. The method of claim 18, further comprising the step of moving the first wing and the second wing into contact with the work surface.

20. The method of claim 19, further comprising the step of applying a chemical sealer to the trim piece and the work surface.
